(19) United States
(12) Patent Application Publication
(10) Pub. No.: US 2016/0057157 A1
(43) Pub. Date: Feb. 25, 2016

(54) VERIFICATION METHOD, APPARATUS, SERVER AND SYSTEM

(71) Applicant: TENCENT TECHNOLOGY (SHENZHEN) COMPANY LIMITED, Shenzhen (CN)

(72) Inventor: Shuai HU, Shenzhen (CN)

(73) Assignee: TENCENT TECHNOLOGY (SHENZHEN) COMPANY LIMITED, Shenzhen (CN)

(21) Appl. No.: 14/932,121

(22) Filed: Nov. 4, 2015

Related U.S. Application Data
(63) Continuation of application No. PCT/CN2013/089541, filed on Dec. 16, 2013.

(30) Foreign Application Priority Data
May 23, 2013 (CN) 201310195280.1

(51) Int. Cl. H04L 29/06; G06F 21/31

(52) U.S. Cl. CPC H04L 63/123; H04L 63/102; H04L 63/08; G06F 21/316

(57) ABSTRACT

Disclosed are a verification method, apparatus, server and system. The method includes: acquiring user data according to user information sent by a terminal, the user data being a set of user network behaviors corresponding to the user information; generating a verification question and a standard answer according to the user data; and interacting with the terminal according to the verification question and the standard answer to complete a verification process. In this way, the user data is acquired, the verification question and the standard answer are generated according to the user data, and an interactive verification is conducted with the terminal according to the verification question and the standard answer.

### CROSS REFERENCE TO RELATED APPLICATIONS

This application is a continuation of International Application No. PCT/CN2013/089541, filed Dec. 16, 2013, claiming priority based on Chinese Patent Application No. 201310195280.1, filed May 23, 2013, the contents of all of which are incorporated herein by reference in their entirety.

### TECHNICAL FIELD

The present disclosure relates to the field of network technologies, and particularly, to a verification method, apparatus, server and system.

### BACKGROUND

With the development of the network technologies, data interaction services performed by the user using the network service are more and more extensively used. However, the hackers largely destroy the network-provided services using some machine programs. For example, hackers continuously send service requests and responses to the server to cause the server to functionally crash down, or violently crack the user's account and password to steal the virtual properties. In view of such problem, it is desired that the network be able to distinguish whether the user is a person or a computer.

The CAPTCHA (Completely Automated Public Turing test to tell Computers and Humans Apart) algorithm is a public automatic program for distinguishing whether the user is a person or a computer, and it can effectively solve the above problem. The direct computer recognition can be effectively prevented by putting randomly generated character information into pictures, distorting the character information and adding some noises thereto. However, it may only be distinguished as whether the user is a computer or a person by artificially recognizing the character information to achieve an effect of ensuring the network service security.

In the process of implementing the embodiments of the present disclosure, the inventor finds that the related art at least has the following defects: with the development of the artificial intelligence and image processing technology, the computer has an increasingly stronger capability of recognizing the character information in an image. In addition, with the occurrence of the professional captcha human bypass workers, the hackers may directly and artificially recognize the verification code, and the combination of the machine and the manpower causes the verification code to lose its function of ensuring the network services security.

### SUMMARY

In view of the above, the embodiments of the present disclosure provide a verification method, apparatus, server and system. The technical solutions are described as follows.

In a first aspect, a verification method is provided, including:

acquiring user data according to user information sent by a terminal, the user data being a set of user network behaviors corresponding to the user information;

generating a verification question and a standard answer according to the user data; and

interacting with the terminal according to the verification question and the standard answer to complete a verification process.

In a second aspect, a verification apparatus is provided, including: an acquiring module configured to acquire user data according to user information sent by a terminal, the user data being a set of user network behaviors corresponding to the user information; a generating module configured to generate a verification question and a standard answer according to the user data acquired by the acquiring module; and a verifying module configured to interact with the terminal according to the verification question and the standard answer generated by the generating module to complete a verification process.

In a third aspect, a server is provided, including: A server, comprising: one or more processors; and a memory; wherein the memory stores one or more programs configured to be performed by the one or more processors, the one or more programs comprising instructions for performing the operations of:

acquiring user data according to user information sent by a terminal, the user data being a set of user network behaviors corresponding to the user information;

generating a verification question and a standard answer according to the user data; and

interacting with the terminal according to the verification question and the standard answer to complete a verification process.

In a fourth aspect, a verification system is provided, including a server and a terminal connected to each other over a wireless or wired network.

The server is configured to: acquire user data according to user information sent by the terminal, the user data being a set of user network behaviors corresponding to the user information; generate a verification question and a standard answer according to the user data; and interact with the terminal according to the verification question and the standard answer to complete a verification process.

In a fifth aspect, a verification system is provided, including a user data center, a server and a terminal. The user data center and the server are connected to each other over a wireless or wired network, the server and the terminal are connected to each other over a wireless or wired network, and the user data center and the terminal are connected to each other over a wireless or wired network.

The user data center is configured to: acquire user data according to user information sent by the terminal, the user data being a set of user network behaviors corresponding to the user information; generate a verification question and a standard answer according to the user data; and send the verification question and the standard answer to the server, such that the server interacts with the terminal to complete a verification process.

In the third aspect, a verification system is provided, including a server and a terminal connected to each other over a wireless or wired network. The server includes the verification apparatus according to the second aspect.

In the fourth aspect, a verification system is provided, including a user data center, a server and a terminal. The user data center and the server are connected to each other over a wireless or wired network, the server and the terminal are connected to each other over a wireless or wired network, and the user data center and the terminal are connected to each other over a wireless or wired network. The user data center includes the verification apparatus according to the second aspect.

The technical solutions according to the embodiments of the present disclosure create the following beneficial effects:

The user data is acquired, the verification question and the standard answer are generated according to the user data, and interaction is performed with the terminal according to the verification question and the standard answer to complete the verification process, thereby ensuring the network service security, and solving the problem that the network service security cannot be ensured by the verification code technology due to attacks launched by combining the machine and the manpower. Since the verification question is generated based on the user data and is private to the user, the network service security is ensured even if the hackers launch attacks by combining the machine and the manpower.

### BRIEF DESCRIPTION OF THE DRAWINGS

In order to more clearly describe the technical solutions of the embodiments of the present disclosure, the drawings to be used in the descriptions of the embodiments will be briefly introduced as follows. Obviously, the following drawings just illustrate some embodiments of the present disclosure, and a person skilled in the art may derive other drawings from those drawings without paying any creative effort.

FIG. 1 is a flowchart of a verification method according to an embodiment of the present disclosure;

FIG. 2 is a flowchart of a verification method according to another embodiment of the present disclosure;

FIG. 3a is a schematic structural diagram of an implementation environment of the verification method according to another embodiment of the present disclosure;

FIG. 3b is schematic diagram of a terminal verification interface in an implementation environment of the verification method according to another embodiment of the present disclosure;

FIG. 4 is a structural block diagram of a verification apparatus according to an embodiment of the present disclosure;

FIG. 5 is a structural block diagram of a verification apparatus according to another embodiment of the present disclosure;

FIG. 6 is a structural block diagram of a verification apparatus according to still another embodiment of the present disclosure;

FIG. 7 is a schematic structural diagram of a verification system according to an embodiment of the present disclosure; and

FIG. 8 is a schematic structural diagram of a verification system according to another embodiment of the present disclosure; and

FIG. 9 is a structural schematic diagram of a server or a user data center according to an embodiment of the present disclosure.

### DETAILED DESCRIPTION

In the process of using some network services, a user needs an identity authentication using a terminal and a server providing the network services, and uses the network services only when the authentication is successful. However, if the user's identity information is unauthorizedly stolen by hackers, the hackers would continuously access the server of the website using some machine programs and hence cause the server of the website to crash down. Some hackers steal the user's identity verification information using some violent cracking programs, and the user's network virtual properties may be damaged. In order to prevent the network service resources from being unauthorizedly used and ensure the security of the user's network virtual properties, the server providing network services needs to distinguish whether the user is a person or a computer.

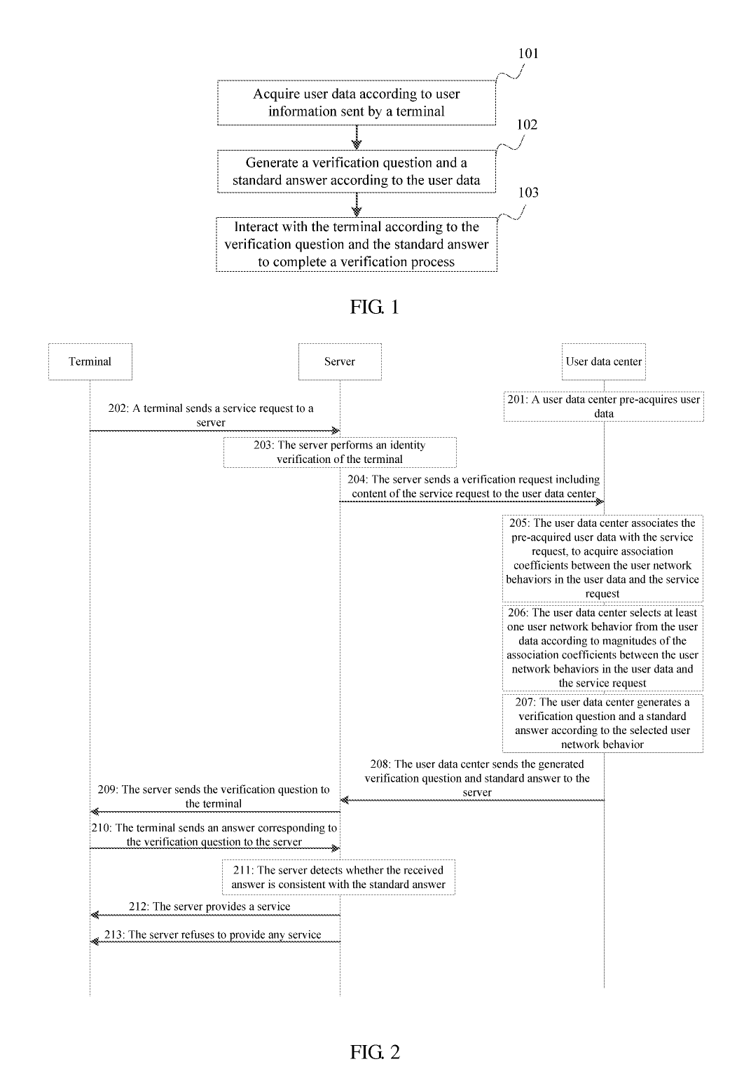

Referring to FIG. 1, a methodological flowchart of a verification method according to an embodiment of the present disclosure is illustrated. The verification method includes the following steps:

Step 101: Acquiring user data according to user information sent by a terminal.

A server acquires the user data according to the user information sent by the terminal, the user data being a set of user network behaviors corresponding to the user information.

Step 102: Generating a verification question and a standard answer according to the user data.

The server generates the verification question and the standard answer according to the user data.

Step 103: Interacting with the terminal according to the verification question and the standard answer to complete a verification process.

The server interacts with the terminal according to the verification question and the standard answer to complete the verification process.

In conclusion, in the verification method according to the embodiment of the present disclosure, by acquiring the user data, generating the verification question and the standard answer according to the user data, and interacting with the terminal according to the verification question and the standard answer to complete the verification process, the network service security is ensured, and the problem that the network service security cannot be ensured by the verification code technology due to attacks launched by combining the machine and the manpower is solved. Since the verification question is generated based on the user data and is private to the user, the network service security is ensured even if the hackers launch attacks by combining the machine and the manpower.

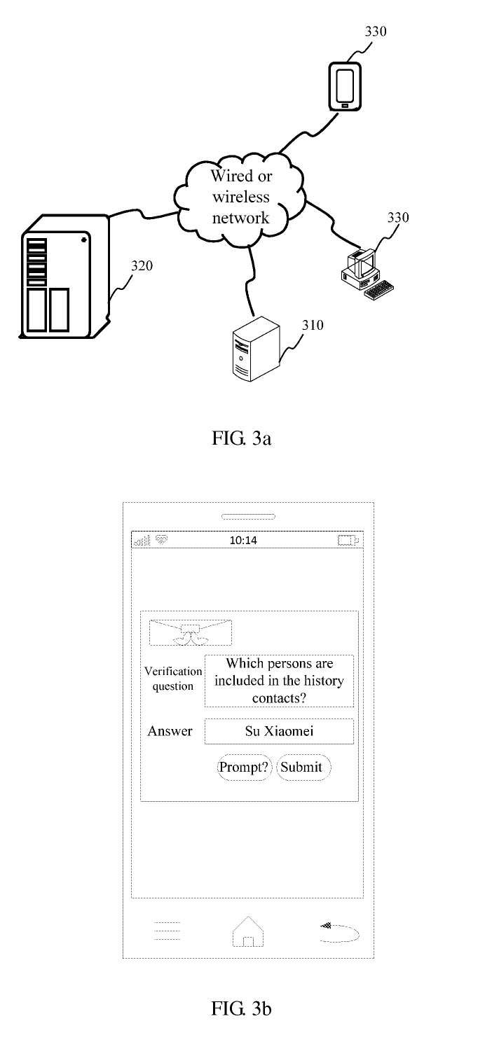

Referring to FIG. 2, a flowchart of a verification method according to another embodiment of the present disclosure is illustrated. The embodiment of the present disclosure is described using an example where the verification method is applied to an implementation environment as shown in FIG. 3, which includes a server 310, a user data center 320 and a terminal 330. The terminal may be any one of a desktop computer, a notebook computer, a smart phone and a tablet computer. The verification method includes the following steps:

Step 201: A user data center pre-acquires user data.

The user data center 320 pre-collects and stores user data of a user under the user authorization, where the user data is a set of user network behaviors corresponding to the user information, and the user network behaviors include, but not limited to, at least one of an application historically used by the user, an instant messenger historically used by the user, a website historically accessed by the user, a system tool historically used by the user and a network tool historically used by the user. For example, the application historically used by the user is XX Island Survival, the instant messenger historically used by the user is X-chat, the website historically accessed by the user is XX Forum, and the system tool historically used by the user is X Master, and the network tool historically used by the user is XX-download.

Specifically, in one implementation, when the user performs the above network behavior by interacting with the server 310, the server 310 records the user network behavior in real time, and sends the recorded user network behavior to the user data center 320 under the user authorization. In another implementation, the terminal 330 records the user network behavior and generates corresponding user data, and sends the recorded user network behavior to the user data center 320 under the user authorization, such that the user data center 320 generates a verification question and a standard answer according to the user data.

Step 202: A terminal sends a service request to a server.

When using a network service, the user firstly sends a service request including user information to the server 310. For example, when accessing a website XX, the user needs to input a user name and a password in a login interface provided on the website XX using the terminal 330, and the terminal 330 sends a service request including the user name and the password to the server 310 of the website XX.

Correspondingly, the server 310 receives the service request sent by the terminal 330.

Step 203: The server performs an identity verification of the terminal.

Upon receiving the user name and the password sent by the terminal 330, the server 310 performs an identity verification of the user.

Step 204: The server sends a verification request including the content of the service request to the user data center.

Upon performing the identity verification of the user, the server 310 sends a verification request including the content of the service request to the user data center 320, the verification request requesting a verification question and a standard answer to be generated based on the user data of the user. Correspondingly, the user data center 320 receives the verification request.

It should be noted that, the verification request sent from the server to the user data center may further include verification level information, i.e., a difficulty level of the verification question applied for. For example, when the service applied for by the service request sent by the terminal concerns important information such as the user properties, the user can apply for a verification question of higher level, such that the user data center generates a verification question more private to the user.

Step 205: The user data center associates the pre-acquired user data with the service request, to acquire association coefficients between the user network behaviors in the user data and the service request.

The user data center 320 associates the pre-acquired user data with the service request, to acquire association coefficients between the user network behaviors in the user data and the service request. For example, if the current service request is for a mailbox service, the association coefficients between the mailbox service and various user network behaviors in the user data are acquired. The embodiment of the present disclosure is described using an example where the user data includes the application historically used by the user, the instant messenger historically used by the user, the website historically accessed by the user, the system tool historically used by the user and the network tool historically used by the user. It is assumed that the association coefficients between the above five items included in the user data and the mailbox service are 1, 7, 6, 3 and 2, respectively.

It should be noted that, the user network behaviors in the user data may include some other network behaviors of the user. The user data center collects the user network behaviors as far as possible, which are usually known to the user himself, while cannot be directly acquired by the hackers or the computer.

Step 206: The user data center selects at least one user network behavior from the user data according to magnitudes of the association coefficients between the user network behaviors in the user data and the service request.

The user data center 320 selects at least one user network behavior from the user data according to the magnitudes of the association coefficients between the acquired user network behaviors and the service request. For example, when the association coefficients between the above network behaviors and the mailbox service are 1, 7, 6, 3 and 2, respectively, the user network behavior corresponding to the maximum association coefficient 7, i.e., the instant messenger historically used by the user, will be selected.

It should be noted that, the user data center may select the user network behaviors in the user data according to other factors. For example, the user data center may select the user network behaviors in the user data according to the time sequence of the user network behaviors. The embodiment of the present disclosure is just described using an example where the selection is made according to the association coefficients between the user network behavior and the service request.

In addition, the user data center can bypass steps 205-206 and directly enter step 207, i.e., it randomly selects at least one user network behavior from the pre-acquired user network behaviors, without selecting the user network behaviors in the user data.

Step 207: The user data center generates a verification question and a standard answer according to the selected user network behavior.

The user data center 320 generates a verification question and a standard answer according to the selected user network behavior.

When the selected user network behaviors include the application historically used by the user, the contents involved in the verification question and the standard answer include at least one of a name, a content feature and relevant information of the historically used application. For example, when the application historically used by the user includes XX Island Survival, the verification question and the standard answer include at least one of “what is the name of the historically used application” (the standard answer is XX Island Survival), “what is the level of the user in the historically used application” (the standard answer is assumed as the 8^{th} level), and “who is the ally of the user in the historically used application” (the standard answer is assumed as the Hulk).

When the selected user network behaviors include the instant messenger historically used by the user, the contents involved in the verification question and the standard answer include at least one of a name of the historically used instant messenger, history contacts and history contact records.

For example, when the instant messenger historically used by the user includes X-chat, the verification question and the standard answer include at least one of “what is the name of the historically used instant messenger” (the standard answer is X-chat), “which persons are included in the history contacts” (the standard answer is assumed as including Su Xiaomei), and “which information is included in the history contact records” (the standard answer is assumed as including stock information).

When the selected user network behaviors include the website historically accessed by the user, the contents involved in the verification question and the standard answer include at least one of a name of the historically accessed website, an address of the historically accessed website, input information of the historically accessed website and stored user information in the historically accessed website. For example, when the name of the website historically accessed by the user includes XX forum, the verification question and the standard answer include at least one of “what is the name of the historically accessed website” (the standard answer is XX Forum), “what is the address of the historically accessed website” (the standard answer is www.Xclub.com), “what information is inputted in the historically accessed website” (the standard answer is assumed as “how to prevent hacking”) and “what is the user name stored in the historically accessed website” (the standard answer is assumed as “Bai Xiaosheng”).

When the selected user network behaviors include the system tool historically used by the user, the contents involved in the verification question and the standard answer include at least one of a name of the historically used system tool, a latest time of using the system tool, version information of the historically used system tool, and a function and an effect of the historically used system tool. For example, when system tool historically used by the user includes X Master, the verification question and the standard answer include at least one of “what is the name of the historically used system tool” (the standard answer is X Master), “what is the latest time of using the system tool” (the standard answer is assumed as May 10, 2013), “what is the version number of the historically used system tool” (the standard answer is assumed as V7.99.1234) and “which functions of the system tool are historically used” (the standard answer is assumed as One Touch Optimize).

When the selected user network behaviors include the network tool historically used by the user, the contents involved in the verification question and the standard answer include at least one of a name of the historically used network tool, a latest time of using the network tool, the version information of the historically used network tool, and a function and an effect of the historically used network tool. For example, when network tool historically used by the user includes XX Download, the verification question and the standard answer include at least one of “what is the name of the historically used network tool” (the standard answer is XX Download), “what is the latest time of using the network tool” (the standard answer is assumed as Apr. 23, 2013), “what is the version number of the historically used network tool” (the standard answer is assumed as 5.7) and “what data is downloaded by the historically used network tool” (the standard answer is assumed as So Young).

To be noted, the verification question and the standard answer are generated according to the user data, and they are not limited to the specific questions listed as above.

Step 208: The user data center sends the generated verification question and standard answer to the server.

Upon generating the verification question and the standard answer, the user data center 320 sends the verification question and the standard answer to the server 310, such that the server 310 interacts with the terminal 330 to complete the verification process. For example, the verification question and the standard answer sent by the user data center are “which persons are included in the history contacts” (the standard answer is assumed as including Su Xiaomei).

Correspondingly, the server 310 receives the verification question and the standard answer sent by the user data center.

Step 209: The server sends the verification question to the terminal.

Upon receiving the verification question and the standard answer sent by the user data center 320, the server 310 sends the verification question to the terminal 330. For example, the server 310 sends “which persons are included in the history contacts” to the terminal 330.

Correspondingly, the terminal 330 receives the verification question sent by the server 310.

Step 210: The terminal sends an answer corresponding to the verification question to the server.

The user answers the question according to his memory, and sends the question answer to the server 310 by using the terminal 330. For example, as shown in FIG. 3b, the user inputs Su Xiaomei as the answer according to his memory, and clicks Submit.

Correspondingly, the server 310 receives the answer corresponding to the verification question sent by the terminal 330.

Step 211: The server detects whether the received answer is consistent with the standard answer.

The server 310 detects whether the received answer sent by the user with the terminal 330 is consistent with the standard answer sent by the user data center 320; if consistent, step 212 is performed; and otherwise, step 213 is performed.

Step 212: The server provides a service.

If a detection result is that the received answer is consistent with the standard answer, the server 310 provides a service. For example, the server 310 provides a mailbox service, and the user may log in to a mailbox to perform corresponding operation.

Step 213: The server refuses to provide any service.

If a detection result is that the received answer is inconsistent with the standard answer, the server 310 refuses to provide any service. For example, the server 310 does not provide the mailbox service, and the user may not log in to the mailbox to perform corresponding operation.

It should be noted that the steps of acquiring the user data and generating the verification question according to the user data performed by the user data center in the embodiment may also be performed by the server. To be specific, the server acquires the user data, generates the verification question and the standard answer according to the acquired user data, and interacts with the terminal according to the verification question and the standard answer to complete the verification process.

In conclusion, in the verification method according to the embodiment of the present disclosure, the verification question and the standard answer are generated according to the pre-stored user data. In the generation process, the verification question and the standard answer are generated by selecting at least one user network behavior according to magnitudes of the association coefficients between the user network behaviors in the user data and the service applied for. The generated verification question and standard answer are private to the user, and cannot be acquired by the hackers, thereby solving the problem that the network service security cannot be ensured by the verification code technology due to attacks launched by combining the machine and the manpower, and achieving an effect that the network service security is ensured even if the hackers launch attacks by combining the machine and the manpower.

It should be noted that, since the verification question and the standard answer are generated according to the user data in the verification method according to the embodiment of the present disclosure, the difficulty level of the verification question can be increased according to the actual conditions, and a certain logical processing for the user data can be performed in advance. Therefore, the verification method has a strong scalability, and does not require a noise adding processing of the traditional verification code technology. Nevertheless, under certain circumstances, the verification method may be combined with the traditional verification code technology and other verification technology, so as to better ensure the network service security.

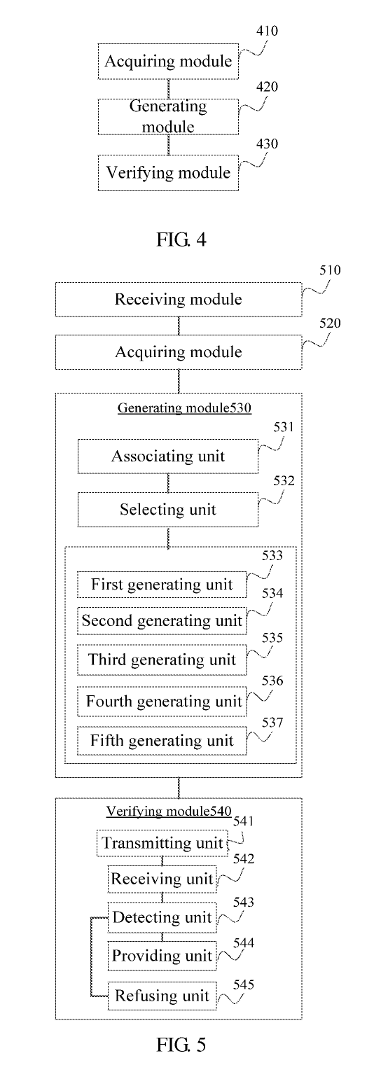

Referring to FIG. 4, a structural block diagram of a verification apparatus according to an embodiment of the present disclosure is illustrated. The verification apparatus may be implemented as the whole or a part of a server or a user data center by using software, hardware or a combination thereof.

The verification apparatus includes: an acquiring module 410 configured to acquire user data according to user information sent by a terminal, the user data being a set of user network behaviors corresponding to the user information; a generating module 420 configured to generate a verification question and a standard answer according to the user data acquired by the acquiring module 410; and a verifying module 430 configured to interact with the terminal according to the verification question and the standard answer generated by the generating module 420 to complete a verification process.

In conclusion, the verification apparatus according to the embodiment of the present disclosure acquires the user data, generates the verification question and the standard answer according to the user data, and interacts with the terminal according to the verification question and the standard answer to complete the verification process, thereby ensuring the network service security, and solving the problem that the network service security cannot be ensured by the verification code technology due to attacks launched by combining the machine and the manpower. Since the verification question is generated based on the user data and is private to the user, the network service security is ensured even if the hackers launch attacks by combining the machine and the manpower.

Referring to FIG. 5, a structural block diagram of a verification apparatus according to another embodiment of the present disclosure is illustrated. The verification apparatus may be implemented as the whole or a part of a server by using software, hardware or a combination thereof. The verification apparatus includes: a receiving module 510, an acquiring module 520, a generating module 530 and a verifying module 540.

The receiving module 510 is configured to receive a service request including user information sent by a terminal.

The acquiring module 520 is configured to acquire user data according to the user information included in the service request received by the receiving module 510, the user data being a set of user network behaviors corresponding to the user information, where the user network behaviors includes at least one of an application historically used by the user, an instant messenger historically used by the user, a website historically accessed by the user, a system tool historically used by the user, and a network tool historically used by the user.

The generating module 530 is configured to generate a verification question and a standard answer according to the user data acquired by the acquiring module 520.

The generating module 530 includes: at least one of an associating unit 531, a selecting unit 532, a first generating unit 533, a second generating unit 534, a third generating unit 535, a fourth generating unit 536 and a fifth generating unit 537.

The associating unit 531 is configured to associate the user data with the service request, to acquire association coefficients between the user network behaviors in the user data and the service request.

The selecting unit 532 is configured to select at least one user network behavior from the user data according to magnitudes of the association coefficients between the user network behaviors in the user data and the service request acquired by the associating unit 531.

The first generating unit 533 is configured to generate, when the user network behaviors selected by the selecting unit 532 include the application historically used by the user, the verification question and the standard answer, where the contents involved in the verification question and the standard answer include at least one of a name of the historically used application, a content feature of the historically used application, and relevant information of the historically used application.

The second generating unit 534 is configured to generate, when the user network behaviors selected by the selecting unit 532 include the instant messenger historically used by the user, the verification question and the standard answer, where the contents involved in the verification question and the standard answer include at least one of a name of the historically used instant messenger, history contacts for the historically used instant messenger, and history contact records for the historically used instant messenger.

The third generating unit 535 is configured to generate, when the user network behaviors selected by the selecting unit 532 include the website historically accessed by the user, the verification question and the standard answer, where the contents involved in the verification question and the standard answer include at least one of a name of the historically accessed website, an address of the historically accessed website, input information in the historically accessed website, and stored user information in the historically accessed website.

The fourth generating unit 536 is configured to generate, when the user network behaviors selected by the selecting unit 532 include the system tool historically used by the user, the verification question and the standard answer, where the contents involved in the verification question and the standard answer include at least one of a name of the historically used system tool, a latest time of using the system tool, version information of the historically used system tool, and a function and an effect of the historically used system tool.

The fifth generating unit 537 is configured to generate, when the user network behaviors selected by the selecting unit 532 include the network tool historically used by the user, the verification question and the standard answer, where the contents involved in the verification question and the standard answer include at least one of a name of the historically used network tool, a latest time of using the network tool, the version information of the historically used network tool, and a function and an effect of the historically used network tool.

The verifying module 540 is configured to interact with the terminal according to the verification question and the standard answer generated by the generating module, to complete a verification process.

The verifying module 540 includes: a sending unit 541, a receiving unit 542, a detecting unit 543, a providing unit 544 and a refusing unit 545.

The sending unit 541 is configured to send the verification question to the terminal; The receiving unit 542 is configured to receive from the terminal an answer corresponding to the verification question sent by the sending unit 541.

The detecting unit 543 is configured to detect whether the answer received by the receiving unit 542 is consistent with the standard answer.

The providing unit 544 is configured to provide a service when a detection result of the detecting unit 543 is that the received answer is consistent with the standard answer.

The refusing unit 545 is configured to refuse to provide any service when a detection result of the detecting unit 543 is that the received answer is inconsistent with the standard answer.

In conclusion, the verification apparatus according to the embodiment of the present disclosure generates the verification question and the standard answer according to the pre-stored user data. In the generation process, the verification question and the standard answer are generated by selecting at least one user network behavior according to magnitudes of the association coefficients between the user network behaviors in the user data and the service applied for. The generated verification question and standard answer are private to the user, and cannot be directly acquired by the hackers, thereby solving the problem that the network service security cannot be ensured by the verification code technology due to attacks launched by combining the machine and the manpower, and achieving an effect that the network service security is ensured even if the hackers launch attacks by combining the machine and the manpower.

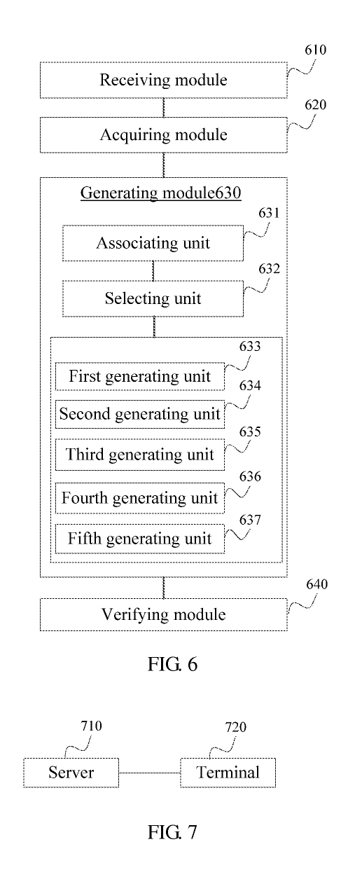

Referring to FIG. 6, a structural block diagram of a verification apparatus according to still another embodiment of the present disclosure is illustrated. The verification apparatus may be implemented as the whole or a part of a user data center by using software, hardware or a combination thereof. The verification apparatus includes: a receiving module 610, an acquiring module 620, a generating module 630 and a verifying module 640.

The receiving module 610 is configured to receive a service request including user information sent by a terminal.

The acquiring module 620 is configured to acquire user data according to the user information included in the service request received by the receiving module 610, the user data being a set of user network behaviors corresponding to the user information, and the user network behaviors including at least one of an application historically used by the user, an instant messenger historically used by the user, a website historically accessed by the user, a system tool historically used by the user and a network tool historically used by the user.

The generating module 630 is configured to generate a verification question and a standard answer according to the user data acquired by the acquiring module 620.

The generating module 630 includes: at least one of an associating unit 631, a selecting unit 632, a first generating unit 633, a second generating unit 634, a third generating unit 635, a fourth generating unit 636, and a fifth generating unit 637.

The associating unit 631 is configured to associate the user data with the service request, to acquire association coefficients between the user network behaviors in the user data and the service request;

The selecting unit 632 is configured to select at least one user network behavior from the user data according to magnitudes of the association coefficients between the user network behaviors in the user data and the service request acquired by the associating unit 631.

The first generating unit 633 is configured to generate, when the user network behaviors selected by the selecting unit 632 include the application historically used by the user, the verification question and the standard answer, where the contents involved in the verification question and the standard answer include at least one of a name of the historically used application, a content feature of the historically used application, and relevant information of the historically used application.

The second generating unit 634 is configured to generate, when the user network behaviors selected by the selecting unit 632 include the instant messenger historically used by the user, the verification question and the standard answer, where the contents involved in the verification question and the standard answer include at least one of a name of the historically used instant messenger, history contacts for the historically used instant messenger, and history contact records for the historically used instant messenger.

The third generating unit 635 is configured to generate, when the user network behaviors selected by the selecting unit 632 include the website historically accessed by the user, the verification question and the standard answer, where the contents involved in the verification question and the standard answer include at least one of a name of the historically accessed website, an address of the historically accessed website, input information in the historically accessed website, and stored user information in the historically accessed website.

The fourth generating unit 636 is configured to generate, when the user network behaviors selected by the selecting unit 632 include the system tool historically used by the user, the verification question and the standard answer, where the contents involved in the verification question and the standard answer include at least one of a name of the historically used system tool, a latest time of using the system tool, version information of the historically used system tool, and a function and an effect of the historically used system tool.

The fifth generating unit 637 is configured to generate, when the user network behaviors selected by the selecting unit 632 include the network tool historically used by the user, the verification question and the standard answer, where the contents involved in the verification question and the standard answer include at least one of a name of the historically used network tool, a latest time of using the network tool, the version information of the historically used network tool, and a function and an effect of the historically used network tool.

The verifying module 640 is configured to send the verification question and the standard answer to a server which interacts with the terminal, such that the server interacts with the terminal to complete a verification process.

In conclusion, the verification apparatus according to the embodiment of the present disclosure generates the verification question and the standard answer according to the pre-stored user data. In the generation process, the verification question and the standard answer are generated by selecting at least one user network behavior according to magnitudes of the association coefficients between the user network behaviors in the user data and the service applied for. The generated verification question and standard answer are private to the user, and cannot be directly acquired by the hackers, thereby solving the problem that the network service security cannot be ensured by the verification code technology due to attacks launched by combining the machine and the manpower, and achieving an effect that the network service security is ensured even if the hackers launch attacks by combining the machine and the manpower.

Referring to FIG. 7, a structural schematic diagram of a verification system according to an embodiment of the present disclosure is illustrated. The verification system includes a server 710 and a terminal 720 connected to each other over a wireless or wired network.

The server 710 includes the verification apparatus according to the embodiment as illustrated in FIG. 4 or 5.

In conclusion, the verification system according to the embodiment of the present disclosure generates the verification question and the standard answer according to the pre-stored user data. In the generation process, the verification question and the standard answer are generated by selecting at least one user network behavior according to magnitudes of the association coefficients between the user network behaviors in the user data and the service applied for. The generated verification question and standard answer are private to the user, and cannot be acquired by the hackers, thereby solving the problem that the network service security cannot be ensured by the verification code technology due to attacks launched by combining the machine and the manpower, and achieving an effect that the network service security is ensured even if the hackers launch attacks by combining the machine and the manpower.

Referring to FIG. 8, a schematic structural diagram of a verification system according to another embodiment of the present disclosure is illustrated. The verification system includes a user data center 810, a server 820 and a terminal 830. The user data center 810 and the server 820 are connected to each other over a wireless or wired network. The server 820 and the terminal 830 are connected to each other over a wireless or wired network. The user data center 810 and the terminal 830 are connected to each other over a wireless or wired network.

The user data center 810 includes the verification apparatus according to the embodiment as illustrated in FIG. 4 or 6.

In conclusion, the verification system according to the embodiment of the present disclosure generates the verification question and the standard answer according to the pre-stored user data. In the generation process, the verification question and the standard answer are generated by selecting at least one user network behavior according to magnitudes of the association coefficients between the user network behaviors in the user data and the service applied for. The generated verification question and standard answer are private to the user, and cannot be acquired by the hackers, thereby solving the problem that the network service security cannot be ensured by the verification code technology due to attacks launched by combining the machine and the manpower, and achieving an effect that the network service security is ensured even if the hackers launch attacks by combining the machine and the manpower.

It should be noted that, when performing verification, the verification apparatus according to the above embodiment is just described using the example of the division of the functional modules. In practical applications, those functions may be allocated to be performed by different functional modules upon demand, i.e., the internal structure of the apparatus is divided into different functional modules to complete all or a part of the aforementioned functions. In addition, the verification apparatus according to the above embodiment belongs to the same conception as the verification method. Please refer to the method embodiment for the specific implementation process of the verification apparatus, which is not described herein any further.

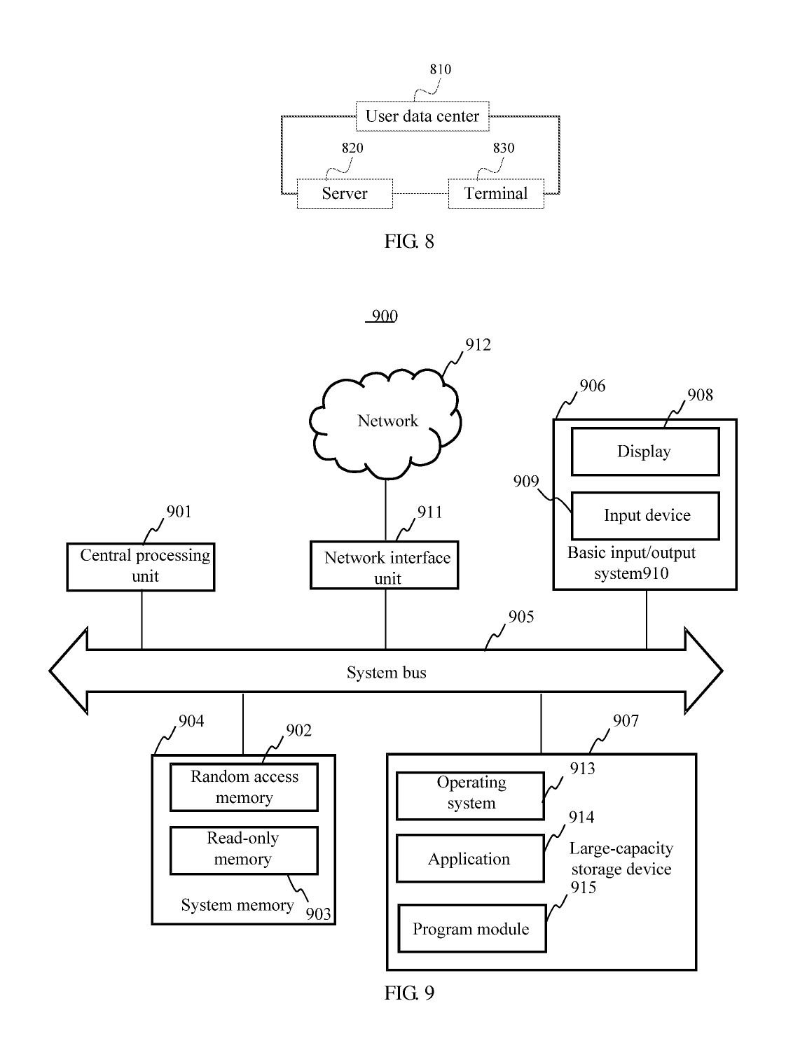

Referring to FIG. 9, a structural schematic diagram of a server or a user data center according to an embodiment of the present disclosure is illustrated. The server or the user data center 900 includes a central processing unit (CPU) 901, a system memory 904 including a Random Access Memory (RAM) 902 and a read only memory (ROM) 903, and a system bus 905 connecting the system memory 904 with the CPU 901. The server or the user data center 900 further includes a basic Input/Output (I/O) system 906 for facilitating the information transmission between various devices in a computer, and a mass storage device 907 for storing an operating system 913, an application 914 and a program module 915.

The basic I/O system 906 includes a display 908 for displaying information, and an input device 909 for a user to input information, such as a mouse, a keyboard, etc. In which, the display 908 and the input device 909 are both connected to the CPU 901 by using an I/O controller 910 that is connected to the system bus 905. The basic I/O system 906 may further include the I/O controller 910 for receiving and processing an input from other devices such as a keyboard, a mouse and an electronic stylus. Similarly, the I/O controller 910 further provides an output to a display screen, a printer or other types of output devices.

The mass storage device 907 is connected to the CPU 901 by using a mass storage controller (not illustrated) connected to the system bus 905. The mass storage device 907 and its associated computer readable medium provide a nonvolatile storage to the server or the user data center 900. That is, the mass storage device 907 may include a computer readable medium (not illustrated) such as a hard disc or a CD-ROM driver.

Without loss of generality, the computer readable medium may include a computer storage medium and a communication medium. The computer storage medium includes volatile and nonvolatile, movable and immovable mediums realized with any method or technology which stores the information such as computer readable instruction, data structure, program module or other data. The computer storage medium includes RAM, ROM, EPROM, EEPROM, flash or other solid memory, CD-ROM, DVD or other optical memory, tape cartridge and tape/disc storage device or other magnetic storage devices. Nevertheless, a person skilled in the art shall appreciate that the computer storage medium is not limited thereto. The system memory 904 and the mass storage device 907 may be collectively referred to as the memory.

According to the embodiments of the present disclosure, the server or the user data center 900 may be connected to the remote computer in the network over a network such as the Internet. That is to say, the server 900 may be connected to a network 912 by using a network interface unit 911 that is connected to the system bus 905, or the server 900 may be connected to other type of network or remote computer system (not illustrated) by using the network interface unit 911.

The memory further includes one or more programs stored in the memory and containing the instructions for performing the verification method according to the embodiment of the present disclosure.

The serial numbers of the embodiments of the present disclosure are just given for the convenience of description, rather than indicating the preferences thereof.

Persons of ordinary skill in the art should understand that all or part of steps of the preceding methods may be implemented by hardware or hardware following instructions of programs. The programs may be stored in a non-transitory computer-readable storage medium, and may be executed by at least one processor. The storage medium may be a ROM, a magnetic disk, or a compact disc-read only memory.

The above descriptions are just preferred embodiments of the present disclosure, rather than limiting the present disclosure. Any amendment, equivalent replacement, improvement, etc. made under the spirit and principle of the present disclosure shall fall within the protection scope of the present disclosure.

What is claimed is:

1. A verification method, comprising:
acquiring user data according to user information sent by a terminal, the user data being a set of user network behaviors corresponding to the user information;
generating a verification question and a standard answer according to the user data; and
interacting with the terminal according to the verification question and the standard answer to complete a verification process.

2. The method according to claim 1, wherein the user network behaviors comprise at least one of an application historically used by the user, an instant messenger historically used by the user, a website historically accessed by the user, a system tool historically used by the user, and a network tool historically used by the user.

3. The method according to claim 2, wherein the generating a verification question and a standard answer according to the user data comprises:
selecting a part of or all the user network behaviors in the user data;
when the selected user network behaviors comprise the application historically used by the user, the contents involved in the verification question and the standard answer comprise at least one of a name of the historically used application, a content feature of the historically used application, and relevant information of the historically used application;
when the selected user network behaviors comprise the instant messenger historically used by the user, the contents involved in the verification question and the standard answer comprise at least one of a name of the historically used instant messenger, history contacts for the historically used instant messenger, and history contact records for the historically used instant messenger;
when the selected user network behaviors comprise the website historically accessed by the user, the contents involved in the verification question and the standard answer comprise at least one of a name of the historically accessed website, an address of the historically accessed website, input information in the historically accessed website, and stored user information in the historically accessed website;
when the selected user network behaviors comprise the system tool historically used by the user, the contents involved in the verification question and the standard answer comprise at least one of a name of the historically used system tool, a latest time of using the system tool, version information of the historically used system tool, and a function and an effect of the historically used system tool; and
when the selected user network behaviors comprise the network tool historically used by the user, the contents involved in the verification question and the standard answer comprise at least one of a name of the historically used network tool, a latest time of using the network tool, the version information of the historically used network tool, and a function and an effect of the historically used network tool.

4. The method according to claim 3, wherein before acquiring the user data according to the user information sent by the terminal, the method further comprising:
receiving a service request including user information sent by the terminal;
before selecting a part of or all the user network behaviors in the user data, the method further comprising:
associating the user data with the service request, to acquire association coefficients between the user network behaviors in the user data and the service request;
selecting a part of or all the user network behaviors in the user data comprises:
selecting at least one user network behavior from the user data according to magnitudes of the association coefficients between the user network behaviors in the user data and the service request.

5. The method according to claim 4, wherein interacting with the terminal according to the verification question and the standard answer to complete the verification process comprises:
sending the verification question to the terminal;
receiving from the terminal an answer corresponding to the verification question;
detecting whether the received answer is consistent with the standard answer; and
providing a service when a detection result is that the received answer is consistent with the standard answer.

6. The method according to claim 4, wherein interacting with the terminal according to the verification question and the standard answer to complete the verification process comprises:
sending the verification question and the standard answer to a server which interacts with the terminal, such that the server interacts with the terminal to complete the verification process.

7. A server, comprising:
one or more processors; and
a memory;
wherein the memory stores one or more programs configured to be performed by the one or more processors, the one or more programs comprising instructions for performing the operations of:
acquiring user data according to user information sent by a terminal, the user data being a set of user network behaviors corresponding to the user information;
generating a verification question and a standard answer according to the user data; and
interacting with the terminal according to the verification question and the standard answer to complete a verification process.

8. The server according to claim 7, wherein the user network behaviors comprise at least one of an application historically used by the user, an instant messenger historically used by the user, a website historically accessed by the user, a system tool historically used by the user, and a network tool historically used by the user.

9. The server according to claim 8, wherein the one or more programs further comprise instructions for performing the operations of:
selecting a part of or all the user network behaviors in the user data;
when the selected user network behaviors comprise the application historically used by the user, the contents involved in the verification question and the standard answer comprise at least one of a name of the historically used application, a content feature of the historically used application, and relevant information of the historically used application;
when the selected user network behaviors comprise the instant messenger historically used by the user, the contents involved in the verification question and the standard answer comprise at least one of a name of the historically used instant messenger, history contacts for the historically used instant messenger, and history contact records for the historically used instant messenger;
when the selected user network behaviors comprise the website historically accessed by the user, the contents involved in the verification question and the standard answer comprise at least one of a name of the historically accessed website, an address of the historically accessed website, input information in the historically accessed website, and stored user information in the historically accessed website;
when the selected user network behaviors comprise the system tool historically used by the user, the contents involved in the verification question and the standard answer comprise at least one of a name of the historically used system tool, a latest time of using the system tool, version information of the historically used system tool, and a function and an effect of the historically used system tool; and
when the selected user network behaviors comprise the network tool historically used by the user, the contents involved in the verification question and the standard answer comprise at least one of a name of the historically used network tool, a latest time of using the network tool, the version information of the historically used network tool, and a function and an effect of the historically used network tool.

10. The server according to claim 9, wherein the one or more programs further comprise instructions for performing the operations of:
receiving a service request including user information sent by the terminal;
associating the user data with the service request, to acquire association coefficients between the user network behaviors in the user data and the service request; and
selecting at least one user network behavior from the user data according to magnitudes of the association coefficients between the user network behaviors in the user data and the service request.

11. The server according to claim 10, wherein the one or more programs further comprise instructions for performing the operations of:
sending the verification question to the terminal;
receiving from the terminal an answer corresponding to the verification question;
detecting whether the received answer is consistent with the standard answer; and
providing a service when a detection result is that the received answer is consistent with the standard answer.

12. The server according to claim 10, wherein when the server is a server of a user data center, the one or more programs further comprise instructions for performing the operations of:
sending the verification question and the standard answer to another server which interacts with the terminal, such that the another server interacts with the terminal to complete the verification process.

13. A verification system, comprising a user data center, a server and a terminal, wherein the user data center and the server are connected to each other over a wireless or wired network, the server and the terminal are connected to each other over a wireless or wired network, and the user data center and the terminal are connected to each other over a wireless or wired network;
the user data center is configured to:
acquire user data according to user information sent by the terminal, the user data being a set of user network behaviors corresponding to the user information;
generate a verification question and a standard answer according to the user data; and
send the verification question and the standard answer to the server, such that the server interacts with the terminal to complete a verification process.
